(19) United States
(12) Patent Application Publication
(10) Pub. No.: US 2013/0101834 A1
(43) Pub. Date: Apr. 25, 2013

(54) LASER-IMAGEABLE FLEXOGRAPHIC PRINTING PRECURSORS AND METHODS OF IMAGING

(71) Applicants: Dana Barshishat, Petah-Tiqva (IL); Eynat Matzner, Adi (IL); Ophira Melamed, Shoham (IL); Shai Costy, Tel Aviv (IL)

(72) Inventors: Dana Barshishat, Petah-Tiqva (IL); Eynat Matzner, Adi (IL); Ophira Melamed, Shoham (IL); Shai Costy, Tel Aviv (IL)

(21) Appl. No.: 13/277,334

(22) Filed: Oct. 20, 2011

(51) Int. Cl. B32B 3/00; B29C 35/08; B32B 15/04; B32B 5/00; H01B 1/24; B32B 9/04

(52) U.S. Cl. 428/332; 252/501.1; 428/411.1; 428/457; 428/221; 264/400; 425/174.4; 977/742

(57) ABSTRACT

A laser-engraveable composition comprises one or more elastomeric rubbers and specific amounts of inorganic, non-infrared radiation absorber fillers, a vulcanizing composition, carbon nanotubes, and other near-infrared radiation absorbers such as non-conductive carbon blacks, within certain weight ratios. This laser-engraveable composition can be used to form various flexographic printing precursors that can be laser-engraved to provide relief images in flexographic printing plates, printing cylinders, or printing sleeves.

### FIELD OF THE INVENTION

This invention relates to laser-imageable (laser-engraveable) flexographic printing precursors comprising a unique laser-engraveable layer composition. This invention also relates to methods of imaging these flexographic printing precursors to provide flexographic printing members in printing plate, printing cylinder, or printing sleeve form.

### BACKGROUND OF THE INVENTION

Flexography is a method of printing that is commonly used for high-volume printing runs. It is usually employed for printing on a variety of soft or easily deformed materials including but not limited to, paper, paperboard stock, corrugated board, polymeric films, fabrics, metal foils, and laminates. Coarse surfaces and stretchable polymeric films are economically printed using flexography.

Flexographic printing members are sometimes known as “relief” printing members (for example, relief-containing printing plates, printing sleeves, or printing cylinders) and are provided with raised relief images onto which ink is applied for application to a printable material. While the raised relief images are inked, the relief “floor” should remain free of ink. The flexographic printing precursors are generally supplied with one or more imageable layers that can be disposed over a backing layer or substrate. Flexographic printing also can be carried out using a flexographic printing cylinder or seamless sleeve having the desired relief image. These flexographic printing members can be provided from flexographic printing precursors that can be “imaged in-the-round” (ITR) using either a photomask or laser-ablatable mask (LAM) over a photosensitive composition (layer), or they can be imaged by direct laser engraving (DLE) of a laser-engraveable composition (layer) that is not necessarily photosensitive.

Flexographic printing precursors having laser-ablatable layers are described for example in U.S. Pat. No. 5,719,009 (Fan), which precursors include a laser-ablatable mask layer over one or more photosensitive layers. This publication teaches the use of a developer to remove unreacted material from the photosensitive layer, the barrier layer, and non-ablated portions of the mask layer.

There has been a desire in the industry for a way to prepare flexographic printing members without the use of photosensitive layers that are cured using UV or actinic radiation and that require liquid processing to remove non-imaged composition and mask layers. Direct laser engraving of precursors to produce relief printing plates and stamps is known, but the need for relief image depths greater than 500 μm creates a considerable challenge when imaging speed is also an important commercial requirement. In contrast to laser ablation of mask layers that require low to moderate energy lasers and fluence, direct engraving of a relief-forming layer requires much higher energy and fluence. A laser-engraveable layer must also exhibit appropriate physical and chemical properties to achieve “clean” and rapid laser engraving (high sensitivity) so that the resulting printed images have excellent resolution and durability.

A number of elastomeric systems have been described for construction of laser-engravable flexographic printing precursors. For example, U.S. Pat. No. 6,223,655 (Shanbaum et al.) describes the use of a mixture of epoxidized natural rubber and natural rubber in a laser-engraveable composition. Engraving of a rubber is also described by S. E. Nielsen in Polymer Testing 3 (1983) pp. 303-310.

U.S. Pat. No. 4,934,267 (Hashimito) describes the use of a natural or synthetic rubber, or mixtures of both, such as acrylonitrile-butadiene, styrene-butadiene and chloroprene rubbers, on a textile support. “Laser Engraving of Rubbers—The Influence of Fillers” by W. Kern et al., October 1997, pp. 710-715 (Rohstoffe Und Anwendendunghen) describes the use of natural rubber, nitrile rubber (NBR), ethylene-propylene-diene terpolymer (EPDM), and styrene-butadiene copolymer (SBR) for laser engraving.

U.S. Pat. No. 6,776,095 (Telser et al.) describes elastomers including an EPDM rubber and U.S. Pat. No. 6,913,869 (Leinenbach et al.) describes the use of an EPDM rubber for the production of flexographic printing plates having a flexible metal support. U.S. Pat. No. 7,223,524 (Hiller et al.) describes the use of a natural rubber with highly conductive carbon blacks. U.S. Pat. No. 7,290,487 (Hiller et al.) lists suitable hydrophobic elastomers with inert plasticizers.

An increased need for higher quality flexographic printing precursors for laser engraving has highlighted the need to solve performance problems that were of less importance when quality demands were less stringent. However, it has been especially difficult to simultaneously improve the flexographic printing precursor in various properties because a change that can solve one problem can worsen or cause another problem.

For example, the rate of imaging is now an important consideration in laser engraving of flexographic printing precursors. Throughput (rate of imaging multiple precursors) by engraving depends upon printing plate precursor width because each precursor is imaged point by point. Imaging, multi-step processing, and drying of UV-sensitive precursors is time consuming but this process is independent of printing plate size, and for the production of multiple flexographic printing plates, it can be relatively fast because many flexographic printing plates can be passed through the multiple stages at the same time.

Copending and commonly assigned U.S. Ser. No. 12/748,475 (filed Mar. 29, 2010 by Melamed, Gal, and Dahan) describes flexographic printing precursors having laser-engraveable layers that include mixtures of high and low molecular weight EPDM rubbers, which mixtures provide improvements in performance and manufacturability.

Copending and commonly assigned U.S. Ser. No. 13/173,430 Docket K000206 (filed Jun. 30, 2011 by Melamed, Gal, and Dahan) describes flexographic printing precursors having laser-engraveable layers that include mixtures of CLCB-EPDM and non-CLCB EPDM rubbers, which mixtures provide improvements in performance, physical properties and manufacturability.

As flexographic imaging (sensitivity) is improved, the need for print quality and consistency increases. In addition, there is a need to make manufacturing as consistent as possible. Laser-engraveable compositions to be compounded tend to have relatively high viscosity, which presents challenges in ensuring excellent mixing of the essential components. This problem is addressed with the invention described in U.S. Ser. No. 12/748,475 (noted above) by incorporating a low viscosity EPDM rubber into the laser-engraveable composition. Compression recovery can then be a challenge because a good compression rate and printability are generally associated with high molecular weight elastomers in relatively high viscosity compositions.

As part of the need to produce the printed output in minimum time, flexographic printing has become faster. For flexographic printing plates, there is a limitation in press speed because printing plates are reversibly bonded to the press cylinder and at high press speed there is a danger of the printing plate lifting off the cylinder under centripetal force. Flexographic printing sleeves do not have this problem.

Flexographic printing plates and flexographic printing sleeves can also exhibit an additional problem from high speed printing. If the printing plate surface is insulating, a static charge can build up. Flexographic printing inks used on the printing press often contain organic solvents that have low flash points and thus printing speeds may be curtailed in order to avoid any danger of explosions. Thus, it is important that the flexographic printing plate or flexographic printing sleeve has a grounded electrical path through the printing press cylinder.

Infrared laser-engraveable flexographic printing plate precursors can contain carbon black to absorb the imaging infrared energy. However, the presence of carbon black in the precursor may alter the imaging speed and printing performances. It can also alter the physical properties of the precursor, for instance, its Durometer hardness, electrical conductivity, and thermal conductivity. In terms of manufacturability, the presence of carbon black can alter the viscosity of the laser-engraveable formulation from which the precursor is manufactured.

In order to obtain high electrical conductivity, it would be obvious for one skilled in the art to use highly conductive carbon blacks in the flexographic printing plate precursors. However, if the conductive carbon blacks in the precursors have high oil absorption (as measured for example by DBP absorption), the manufacturing formulation becomes thick and difficult to use in formulating a laser-engraveable layer. High electrical conductivity more often than not goes hand-in-hand with high thermal conductivity and results in the imaging thermal energy being conducted away from imaging.

There is a need to solve these problems so that the sensitivity and manufacturability of flexographic printing plate precursors is improved, and to improve the conductivity of the precursors using laser-engraveable compositions having a suitable viscosity and compression recovery.

### SUMMARY OF THE INVENTION

The present invention provides a laser-engraveable composition comprising one or more elastomeric rubbers in an amount of at least 30 weight % and up to and including 80 weight %, based on the total laser-engravable composition weight,

the laser-engraveable composition further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of: (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the inorganic non-infrared radiation absorber fillers to the total near-infrared radiation absorbers is from 1:35 to and including 13:1.

In addition, the laser-engraveable composition can be used to provide a flexographic printing precursor that is laser-engraveable to provide a relief image, the flexographic printing precursor comprising a laser—engraveable layer comprising one or more elastomeric rubbers in an amount of at least 30 weight % and up to and including 80 weight %, based on the total laser-engravable composition weight,

the laser-engraveable layer further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of: (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the inorganic non-infrared radiation absorber fillers to the total near-infrared radiation absorbers is from 1:35 to and including 13:1.

Particularly useful embodiments of the flexographic printing precursors of this invention have the laser-engraveable layer disposed on a substrate that comprises a fabric web disposed over a polyester support,

the laser-engraveable layer has a Δ torque (M_{Δ}=M_{H}−M_{L}) of at least 10 and up to and including 25 and a dry thickness of at least 100 μm and up to and including 3,000 μm, and comprises:
a vulcanizing composition that is a mixture of first and second peroxides wherein the first peroxide has a t₉₀ value of at least 1 minute and up to and including 6 minutes as measured at 160° C., and the second peroxide has a t₉₀ value of at least 8 minutes and up to and including 20 minutes as measured at 160° C., and the weight ratio of the vulcanizing composition to the total near-infrared radiation absorbers is from 1:3 to and including 1:1,
a non-conductive carbon black in an amount of at least 8 and up to and including 16 phr, wherein the weight ratio of the carbon black to carbon nanotubes is from 1:1 to and including 4:1,

wherein the weight ratio of the inorganic non-infrared radiation absorber fillers to the total near-infrared radiation absorbers in the laser-engraveable layer is from 1:12 to and including 5:1,

wherein the laser-engraveable layer comprises at least 2 phr and up to and including 60 phr of the one or more inorganic, non-infrared radiation absorber fillers,

wherein the laser-engraveable layer comprises at least 7 phr and up to and including 12 phr of the vulcanizing composition, and

wherein the laser-engraveable layer comprises one or more EPDM elastomeric rubbers and optionally one or more non-CLCB EPDM elastomeric rubbers.

Moreover, this invention provides a patternable element that is laser-engraveable to provide a relief image, the patternable element comprising a laser-engraveable layer comprising one or more elastomeric rubbers in an amount of at least 30 weight % and up to and including 80 weight %, based on the total laser-engravable composition weight,

the laser-engraveable layer further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of: (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the non-infrared radiation absorber fillers to the total near-infrared radiation absorbers is from 1:35 to and including 13:1.

In addition, a method for providing a flexographic printing member comprises:

imaging the laser-engraveable layer of the flexographic printing precursor of the present invention using near-infrared radiation to provide a flexographic printing member with a relief image in the resulting laser-engraved layer with a minimum dry relief depth of at least 50 μm.

In another aspect of this invention, a system for providing a flexographic printing member, comprises:

the flexographic printing precursor of the present invention,

a source of imaging near-infrared radiation that is capable of emitting imaging near-infrared radiation and that is selected from the group consisting of a laser diode, a multi-emitter laser diode, a laser bar, a laser stack, a fiber laser, or a combination thereof, and

a set of optical elements coupled to the one or more sources of imaging near-infrared radiation to direct imaging near-infrared radiation from the one or more sources of imaging near-infrared radiation onto the flexographic printing member.

Still again, a method for preparing the flexographic printing precursor of the present invention comprises:

providing a laser-engraveable composition comprising one or more elastomeric rubbers in an amount of at least 30 weight % and up to and including 80 weight %, based on the total laser-engravable composition weight,

the laser-engraveable composition further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the non-infrared radiation absorber fillers to the total near-infrared radiation absorbers is from 1:35 to and including 13:1, and

formulating the laser-engraveable composition into a laser-engraveable layer.

The present invention solves problems described above with specific amounts of weight ratios of various components including inorganic, non-infrared radiation absorber fillers, vulcanizing composition, carbon nanotubes, and a carbon black. Specifically, these specific laser-engraveable compositions provide desired antistatic properties, physical properties, manufacturing properties, imaging speed, and printing properties to provide commercially acceptable laser-engraveable flexographic printing precursors.

In particular, desired antistatic properties can be achieved with the proper weight ratio between a carbon black and carbon nanotubes while other properties are not diminished. Elastomeric rubbers can be incorporated into the laser-engraveable composition to improve mixing during manufacturing. In addition, the flexographic printing precursors of this invention can be manufactured with improved consistency with less surface defects. The invention composition also exhibits lower swelling in organic solvents such as toluene and mixture of isopropanol and ethyl acetate.

While some embodiments of this invention can be engraved using UV, visible, near-infrared, or carbon dioxide engraving lasers, the laser-engraveable compositions are particularly useful with laser engraving methods using near-infrared radiation sources that have numerous advantages such as higher resolution of imaging and reduced energy consumption.

### DETAILED DESCRIPTION OF THE INVENTION

### Definitions

As used herein to define various components of the laser-engraveable compositions, formulations, and layers, unless otherwise indicated, the singular forms “a”, “an”, and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term's definition should be taken from a standard dictionary.

The term “imaging” refers to laser-engraving of the background areas while leaving intact the non-laser engraved areas of the flexographic printing precursor that will be inked up and printed using a flexographic ink.

The term “flexographic printing precursor” refers to a non-imaged flexographic element of this invention. The flexographic printing precursors include flexographic printing plate precursors, flexographic printing sleeve precursors, and flexographic printing cylinder precursors, all of which can be laser-engraved to provide a relief image using a laser according to the present invention to have a dry relief depth of at least 50 μm and up to and including 4000 μm. Such laser-engraveable, relief-forming precursors can also be known as “flexographic printing plate blanks”, “flexographic printing cylinders”, or “flexographic sleeve blanks”. The laser-engraveable flexographic printing precursors can also have seamless or continuous forms.

By “laser-engraveable”, we mean that the laser-engraveable (or imageable) layer can be imaged using a suitable laser-engraving source including infrared radiation, near-infrared radiation lasers, for example carbon dioxide lasers, Nd:YAG lasers, laser diodes, and fiber lasers that produces heat within the laser-engraveable layer that causes rapid local changes in the laser-engraveable layer so that the imaged regions are physically detached from the rest of the layer or substrate and ejected from the layer and collected using suitable means. Non-imaged regions of the laser-engraveable layer are not removed or volatilized to an appreciable extent and thus form the upper surface of the relief image that is the flexographic printing surface. The breakdown is a violent process that includes eruptions, explosions, tearing, decomposition, fragmentation, oxidation, or other destructive processes that create a broad collection of solid debris and gases. This is distinguishable from, for example, image transfer. “Laser-ablative” and “laser-engraveable” can be used interchangeably in the art, but for purposes of this invention, the term “laser-engraveable” is used to define the imaging according to the present invention in which a relief image is formed in the laser-engraveable layer. It is distinguishable from image transfer methods in which ablation is used to materially transfer pigments, colorants, or other image-forming components.

Unless otherwise indicated, the term “weight %” refers to the amount of a component or material based on the total dry layer weight of the composition or layer in which it is located.

Unless otherwise indicated, the terms “laser-engraveable composition” and “laser-engravable layer formulation” are intended to be the same.

The term “phr” denotes the relationship between a compound or component in the laser-engraveable layer and the total elastomeric rubber dry weight in that layer and refers to “parts per hundred rubber parts”.

The “top surface” is equivalent to the “relief-image forming surface” and is defined as the outermost surface of the laser-engraveable layer and is the first surface of that layer that is struck by imaging (ablating) radiation during the engraving or imaging process.

The “bottom surface” is defined as the surface of the laser-engraveable that is most distant from the imaging radiation.

The term “elastomeric rubber” refers to rubbery materials that generally regain their original shape when stretched or compressed.

The term “non-IR absorptive” means that the material absorbs insufficient infrared radiation so as to contribute to laser engraving to an appreciable extent. Such materials are not intended to provide laser engraving capacity but they can do so to a minor extent compared to the infrared radiation absorbers that can also be present.

Delta torque, Δ torque (M_{Δ}=M_{H}−M_{L}) is defined as equal to the difference between the measure of the elastic stiffness of the vulcanized test specimen at a specified vulcanizing temperature measured within a specific period of time (M_{H}) and the measure of the elastic stiffness of the non-vulcanized test specimen at the same specified vulcanizing temperature taken at the lower point in the vulcanizing curve (M_{L}), according to ASTM D-5289.

### Flexographic Printing Precursors

The flexographic printing precursors of this invention are laser-engraveable to provide a desired relief image, and comprise at least one laser-engraveable layer that is formed from a laser-engraveable composition that comprises one or more elastomeric rubbers in a total amount of generally at least 30 weight % and up to and including 80 weight %, and more typically at least 40 weight % and up to and including 70 weight %, based on the total dry laser-engraveable composition.

Useful elastomeric resins that can be used in the laser-engraveable composition include any of those known in the art for this purpose, including but not limited to, thermosetting or thermoplastic urethane resins that are derived from the reaction of a polyol (such as polymeric diol or triol) with a polyisocyanate or the reaction of a polyamine with a polyisocyanate, copolymers of styrene and butadiene, copolymers of isoprene and styrene, styrene-butadiene-styrene block copolymers, styrene-isoprene-styrene copolymers, other polybutadiene or polyisoprene elastomers, nitrile elastomers, polychloroprene, polyisobutylene and other butyl elastomers, any elastomers containing chlorosulfonated polyethylene, polysulfide, polyalkylene oxides, or polyphosphazenes, elastomeric polymers of (meth)acrylates, elastomeric polyesters, and other similar polymers known in the art.

Other useful elastomeric resins include vulcanized rubbers, such as Nitrile (Buna-N), Natural rubber, Neoprene or chloroprene rubber, silicone rubbers, fluorocarbon rubbers, fluorosilicone rubbers, SBR (styrene-butadiene rubber), NBR (acrylonitrile-butadiene rubber), ethylene-propylene rubber, and butyl rubber. Still other useful elastomeric resins include but are not limited to, poly(cyanoacrylate)s that include recurring units derived from at least one alkyl-2-cyanoacrylate monomer and that forms such monomer as the predominant low molecular weight product during laser-engraving. These polymers can be homopolymers of a single cyanoacrylate monomer or copolymers derived from one or more different cyanoacrylate monomers, and optionally other ethylenically unsaturated polymerizable monomers such as (meth)acrylate, (meth)acrylamides, vinyl ethers, butadienes, (meth)acrylic acid, vinyl pyridine, vinyl phosphonic acid, vinyl sulfonic acid, and styrene and styrene derivatives (such as α-methylstyrene), as long as the non-cyanoacrylate co-monomers do not inhibit the ablation process. The monomers used to provide these polymers can be alkyl cyanoacrylates, alkoxy cyanoacrylates, and alkoxyalkyl cyanoacrylates. Representative examples of poly(cyanoacrylates) include but are not limited to poly(alkyl cyanoacrylates) and poly(alkoxyalkyl cyanoacrylates) such as poly(methyl-2-cyanoacrylate), poly(ethyl-2-cyanoacrylate), poly(methoxyethyl-2-cyanoacrylate), poly(ethoxyethyl-2-cyanoacylate), poly(methyl-2-cyanoacrylate-co-ethyl-2-cyanoacrylate), and other polymers described in U.S. Pat. No. 5,998,088 (Robello et al.).

Yet other useful elastomeric resins are alkyl-substituted polycarbonate or polycarbonate block copolymers that form a cyclic alkylene carbonate as the predominant low molecular weight product during depolymerization from ablation. The polycarbonates can be amorphous or crystalline as described for example in Cols. 9-12 of U.S. Pat. No. 5,156,938 (Foley et al.).

In some embodiments, the laser-engraveable composition or layer comprises one or more elastomeric resins at least one of which is an EPDM elastomeric rubber. Mixtures of EPDM elastomeric rubbers can be used. For example, one or more “high molecular weight” EPDM elastomeric rubbers can be included in the laser-engraveable composition or layer, and these compounds can be obtained from a number of commercial sources as the following products: Keltan® EPDM (from DSM Elastomers), Royalene® EPDM (from Lion Copolymers), Kep® (from Kumho Polychem), Nordel (from DuPont Dow Elastomers). Such high molecular weight EPDM elastomeric rubbers generally have a number average molecular weight of at least 20,000 and up to and including 800,000 and typically of at least 200,000 and up to and including 800,000, and more typically of at least 250,000 and up to and including 500,000.

In addition to, or in place of, the high molecular weight EPDM elastomeric rubber, the laser-engraveable composition or layer can further comprise one or more “low molecular weight” EPDM elastomeric rubbers that are generally in liquid form and have a number average molecular weight of at least 2,000 and up to but less than 20,000, and typically of at least 2,000 and up to and including 10,000, and more typically of at least 2,000 and up to and including 8,000. Such low molecular weight EPDM elastomeric rubbers can also be obtained from various commercial sources, for example as Trilene® EPDM (from Lion Copolymers).

In some embodiments, the laser-engraveable composition or layer comprises: (a) at least one high molecular weight EPDM elastomeric rubber that has a molecular weight of at least 20,000, (b) at least one low molecular weight EPDM elastomeric rubber that has a molecular weight of at least 2,000 and less than 20,000, or (c) a mixture of one or more high molecular weight EPDM elastomeric rubbers each having a molecular weight of at least 20,000 and one or more of the low molecular weight EPDM elastomeric rubbers having a molecular weight of at least 2,000 and less than 20,000, at a weight ratio of high molecule weight EPDM elastomeric rubber to the low molecular weight EPDM elastomeric rubber of from 1:2.5 to and including 16:1, or typically from 1:1 to and including 4:1.

In some embodiments, the laser-engraveable layer (or composition) includes one or more CLCB EPDM elastomeric rubbers. Some of these elastomeric rubbers are commercially available from DSM Elastomers under the product names of Keltan® 8340A, 2340A, and 7341A. Some details of such EPDM elastomeric rubbers are also provided in a paper presented by Odenhamn to the RubberTech China Conference 1998. In general, the CLCB EPDM elastomeric rubbers are prepared from controlled side reactions during the polymerization of the ethylene, propylene, and diene terpolymers in the presence of third generation Zeigler Natta catalysts.

Still other useful elastomeric resins are nanocrystalline polypropylenes as described in more detail in copending and commonly assigned U.S. Serial 13/053,700 (filed Mar. 22, 2011 by Landry-Coltrain and Franklin) that is incorporated herein by reference.

If the laser-engraveable composition comprises at least one EPDM elastomeric rubber, it can optionally include minor amounts (less than 40 phr) of “secondary” resins that are non-EPDM elastomeric rubbers, for example to provide layer structure or reinforcement. These optional resins can include but are not limited to, thermosetting or thermoplastic urethane resins that are derived from the reaction of a polyol (such as polymeric diol or triol) with a polyisocyanate or the reaction of a polyamine with a polyisocyanate, copolymers of styrene and butadiene, copolymers of isoprene and styrene, styrene-butadiene-styrene block copolymers, styrene-isoprene-styrene copolymers, other polybutadiene or polyisoprene elastomers, nitrile elastomers, polychloroprene, polyisobutylene and other butyl elastomers, any elastomers containing chlorosulfonated polyethylene, polysulfide, polyalkylene oxides, or polyphosphazenes, elastomeric polymers of (meth)acrylates, elastomeric polyesters, and other similar polymers known in the art.

Still other useful secondary non-EPDM resins include vulcanized rubbers, such as Nitrile (Buna-N), Natural rubber, Neoprene or chloroprene rubber, silicone rubber, fluorocarbon rubber, fluorosilicone rubber, SBR (styrene-butadiene rubber), NBR (acrylonitrile-butadiene rubber), ethylene-propylene rubber, and butyl rubber. Other useful secondary non-EPDM resins include but are not limited to, poly(cyanoacrylate)s that include recurring units derived from at least one alkyl-2-cyanoacrylate monomer and that forms such monomer as the predominant low molecular weight product during laser-engraving. These polymers can be homopolymers of a single cyanoacrylate monomer or copolymers derived from one or more different cyanoacrylate monomers, and optionally other ethylenically unsaturated polymerizable monomers such as (meth)acrylate, (meth)acrylamides, vinyl ethers, butadienes, (meth)acrylic acid, vinyl pyridine, vinyl phosphonic acid, vinyl sulfonic acid, and styrene and styrene derivatives (such as α-methylstyrene), as long as the non-cyanoacrylate comonomers do not inhibit the ablation process. The monomers used to provide these polymers can be alkyl cyanoacrylates, alkoxy cyanoacrylates, and alkoxyalkyl cyanoacrylates. Representative examples of poly(cyanoacrylates) include but are not limited to poly(alkyl cyanoacrylates) and poly(alkoxyalkyl cyanoacrylates) such as poly(methyl-2-cyanoacrylate), poly(ethyl-2-cyanoacrylate), poly(methoxyethyl-2-cyanoacrylate), poly(ethoxyethyl-2-cyanoacylate), poly(methyl-2-cyanoacrylate-co-ethyl-2-cyanoacrylate), and other polymers described in U.S. Pat. No. 5,998,088 (Robello et al.).

Yet other secondary non-EPDM resins are alkyl-substituted polycarbonate or polycarbonate block copolymers that form a cyclic alkylene carbonate as the predominant low molecular weight product during depolymerization from ablation. The polycarbonates can be amorphous or crystalline as described for example in Cols. 9-12 of U.S. Pat. No. 5,156,938 (Foley et al.).

It is possible to introduce a mineral oil into the laser-engraveable composition or layer formulation. One or more mineral oils can be present in an amount of at least 5 phr and up to and including 15 phr, larger amounts causing insolated properties to the plate.

In most embodiments, the laser-engraveable composition (layer) comprises one or more UV, visible light, near-IR, or IR radiation absorbers that facilitate or enhance laser engraving to form a relief image. While any radiation absorber that absorbs a given wavelength of engraving energy can be used, in most embodiments, the radiation absorbers have maximum absorption at a wavelength of at least 700 nm and at greater wavelengths in what is known as the infrared portion of the electromagnetic spectrum. In particularly useful embodiments, the radiation absorber is a near-infrared radiation absorber having a λₘₐₓ), in the near-infrared portion of the electromagnetic spectrum, that is, having a λₘₐₓ of at least 700 nm and up to and including 1400 nm or at least 750 nm and up to and including 1250 nm, or more typically of at least 800 nm and up to and including 1250 nm. If multiple engraving means having different engraving wavelengths are used, multiple radiation absorbers can be used, including a plurality of near-infrared radiation absorbers.

Particularly useful near-infrared radiation absorbers are responsive to exposure from near-IR lasers. Mixtures of the same or different types of near-infrared radiation absorbers can be used if desired. A wide range of useful near-infrared radiation absorbers include but are not limited to, carbon blacks and other near-IR radiation absorbing organic or inorganic pigments (including squarylium, cyanine, merocyanine, indolizine, pyrylium, metal phthalocyanines, and metal dithiolene pigments), and metal oxides.

Examples of useful carbon blacks include RAVEN® 450, RAVEN® 760 ULTRA®, RAVEN® 890, RAVEN® 1020, RAVEN® 1250 and others that are available from Columbian Chemicals Co. (Atlanta, Ga.) as well as N 293, N 330, N 375, N550, and N 772 that are available from Evonik Industries AG (Switzerland) and Mogul® L, Mogul® E, Emperor 2000, and Regal® 330, and 400, that are available from Cabot Corporation (Boston Mass.). Both non-conductive and conductive carbon blacks (described below) are useful. Some conductive carbon blacks have a high surface area and a dibutyl phthalate (DBP) absorption value of at least 150 ml/100 g, as described for example in U.S. Pat. No. 7,223,524 (Hiller et al.) and measured using ASTM D2414-82 DBP Absorption of Carbon Blacks. Carbon blacks can be acidic or basic in nature. Useful conductive carbon blacks also can be obtained commercially as Sterling C that is available from Akrochem and Ensaco™ 150 P (from Timcal Graphite and Carbon), Hi Black 160 B (from Korean Carbon Black Co. Ltd.), and also include those described in U.S. Pat. No. 7,223,524 (noted above, Col. 4, lines 60-62) that is incorporated herein by reference. Useful carbon blacks also include those that are surface-functionalized with solubilizing groups, and carbon blacks that are grafted to hydrophilic, nonionic polymers, such as FX-GE-003 (manufactured by Nippon Shokubai).

The amount of a carbon black, if present, is at least 3 phr and up to and including 24 phr, or typically at least 8 phr and up to and including 16 phr.

The laser-engraveable composition also includes carbon nanotubes in an amount of at least 3 phr and up to and including 11 phr and typically of at least 4 phr and up to and including 8 phr. Both single wall and multiwall carbon nanotubes are useful but multiwall carbon nanotubes are generally less expensive. Useful carbon nanotubes can be formed by any known methods in the art. The carbon nanotubes can have minimal or no impurities of carbonaceous impurities that are not carbon nanotubes or metal impurities.

Metallic, semi-metallic, and semiconducting carbon nanotubes can be used. Pristine carbon nanotubes with either open or closed ends can be used also. A pristine carbon nanotube has an outer surface that is free of covalently functionalized materials either through synthetic preparation, acid cleanup of impurities, annealing, or directed functionalization. In some embodiments, the carbon nanotubes are functionalized, for example with a hydrophilic species such as carboxylic acid, carboxylate anion (carboxylic acid salt), hydroxyl, sulfur containing groups, carbonyl, phosphates, nitrates or combinations of these hydrophilic species. Other types of functionalization such as polymer, small molecule, or combinations can also be used.

The length of carbon nanotubes can be at least 20 nm and up to and including 1 m, or typically at least 20 nm and up to and including 50 μm. The carbon nanotubes can be present individually or as bundles of multiple carbon nanotubes. The diameter of an individual carbon nanotubes can be at least 0.05 nm and up to and including 5 nm. In bundled form, they can have a diameter of at least 1 nm and up to and including 1 μm, or at least 50 nm and up to and including 20 nm with and lengths of at least 20 nm and up to and including 50 μm.

Some useful commercial examples of multiwall carbon nanotubes include but are not limited to, Baytubes® C 150 P, Baytubes® C 150 HP, Baytubes® C 70 P, and other products that are available from Bayer Material Science. Also useful are NC7000 and Elastocyl® carbon nanotubes that are available from Nanocyl.

When a carbon black is present, the weight ratio of the carbon black (non-conductive or conductive carbon black) to the carbon nanotubes is generally from 1:4 and to and including 8:1, or typically from 1:1 and to and including 4:1. A particularly useful weight ratio of carbon black to carbon nanotubes is from 1:1 and to and including 3:1.

Other useful near-infrared radiation absorbing pigments include, but are not limited to, Heliogen Green, Nigrosine Base, iron (III) oxides, transparent iron oxides, magnetic pigments, manganese oxide, Prussian Blue, and Paris Blue.

A fine dispersion of very small particles of pigmented near-IR radiation absorbers can provide an optimum laser-engraving resolution and ablation efficiency. Suitable pigment particles are those with diameters less than 1 μm.

Dispersants and surface functional ligands can be used to improve the quality of the carbon black, metal oxide, or pigment dispersion so that the near-IR radiation absorber is uniformly incorporated throughout the laser-engraveable composition and layer.

It is also possible that the near-infrared radiation absorber (such as a carbon black, carbon nanotubes, or both) is not dispersed uniformly within the laser-engraveable layer, but it is present in a concentration that is greater near the bottom surface of the laser-engraveable layer than the top surface. This concentration profile can provide a laser energy absorption profile as the depth into the laser-engraveable layer increases. In some instances, the concentration changes continuously and generally uniformly with depth. In other instances, the concentration is varied with layer depth in a step-wise manner. Further details of such arrangements of the near-IR radiation absorbing compound are provided in U.S. Patent Application Publication 2011/0089609 (Landry-Coltrain et al.) that is incorporated herein by reference.

The laser-engraveable composition also comprises at least 1 phr and up to and including 80 phr, or typically at least 2 phr and up to and including 60 phr, of one or more non-infrared radiation absorber fillers. While polymeric (organic) non-infrared radiation absorber fillers can be used, it is preferable that the non-infrared radiation absorber fillers are predominantly or all inorganic in nature.

Useful inorganic non-infrared radiation absorber fillers include but not limited to, various silicas (treated, fumed, or untreated), calcium carbonate, magnesium oxide, talc, barium sulfate, kaolin, bentonite, zinc oxide, mica, titanium dioxide, and mixtures thereof. Particularly useful inorganic non-infrared radiation absorbing fillers are silica, calcium carbonate, and alumina, such as fine particulate silica, fumed silica, porous silica, surface treated silica, sold as Aerosil® from Degussa, Ultrasil® from Evonik, and Cab-O-Sil® from Cabot Corporation, micropowders such as amorphous magnesium silicate cosmetic microspheres sold by Cabot and 3M Corporation, calcium carbonate and barium sulfate particles and microparticles, zinc oxide, and titanium dioxide, or mixtures of two or more of these materials.

Coupling agents can be added for connection between fillers and all of the polymers in the laser-engraveable layer. An example of a coupling agent is silane (Dynsylan® 6498 or Si 69 available from Evonik Degussa Corporation).

Contrary to what is known in the art (for example, “Laser Engraving of Rubbers—The Influence of Fillers” by W. Kern et al., October 1997, 710-715, Rohstoffe Und Anwendendunghen), the use of the inorganic non-infrared radiation absorber fillers does not adversely affect laser-engraveability or sensitivity when used in the amounts and proportions described for this invention. The use of such materials in the practice of this invention can improve the mechanical properties of the flexographic printing precursor. For example, the weight ratio of the inorganic non-infrared radiation absorber fillers to the total near-infrared radiation absorbers (including carbon nanotubes and any other near-infrared radiation absorbers such as carbon blacks) is from 1:35 to and including 13:1, or from 1:12 to and including 5:1. When these weight ratios are used, the hardness of the laser-engraveable layer provides excellent printing quality, low compression set that provides a resistance to changes in the flexographic printing member after impact during each printing impression, and improved imaging speed.

In some embodiments, the flexographic printing precursor comprises a laser-engraveable composition or layer comprising one or more near infrared radiation absorber fillers that includes a non-conductive carbon black having a dibutyl phthalate (DBP) absorption value of less than 110 ml/100 g in an amount of at least 3 phr and up to and including 24 phr, and carbon nanotubes in an amount of at least 3 phr and up to and including 11 phr, wherein the weight ratio of the conductive carbon black to the carbon nanotubes is from 1:4 to and including 8:1. When these weight ratios are used, the result is a laser engraveable flexographic precursor that has desired antistatic properties and desired imaging speed. Similarly useful laser-engraveable compositions can contain a non-conductive carbon black having a dibutyl phthalate (DBP) absorption of at least 110 ml/100 g.

The vulcanizing composition (or crosslinking composition) can crosslink the all elastomeric rubbers and any other resin in the laser-engraveable composition that can benefit from crosslinking. The vulcanizing composition, including all of its essential components, is generally present in the laser-engraveable composition in an amount of at least 3 phr and up to and including 20 phr, or typically of at least 7 phr and up to and including 12 phr.

The weight ratio of the vulcanizing composition to the total near-infrared radiation absorbers is from 1:12 to and including 3:1, and typically from 1:3 and to and including 1:1.

Useful sulfur vulcanizing compositions comprise one or more sulfur and sulfur-containing compounds such as Premix sulfur (insoluble 65%), zinc dibutyl dithiocarbamate (ZDBC), 2-benzothiazolethiol (MBT), and tetraethylthiuram disulfide (TETD). Generally, the sulfur vulcanizing compositions also generally comprise one or more accelerators as additional components, including but not limited to tetramethylthiuram disulfide (TMTD), tetramethylthiuram monosulfide (TMTM), and 4,4′-dithiodimorpholine (DTDM) in a molar ratio of the sulfur or sulfur-containing compound to the accelerator of from 1:12 to 2.5:1. Thus, some useful sulfur vulcanizing compositions consist essentially of: (1) one or more of sulfur or a sulfur-containing compound, and (2) one or more accelerators. Other useful sulfur-containing compounds, accelerators (both primary and secondary compounds), and useful amounts of each are well known in the art.

Other useful vulcanizing compositions are peroxide vulcanizing compositions that comprise one or more peroxides including but not limited to, di(t-butylperoxyisopropyl)benzene, 2,5-dimethyl-2,5 bis(t-butyl)peroxy)hexane, dicumyl peroxide, di(t-butyl)peroxide, butyl 4,4′-di(t-butylperoxy)valerate, 1,1′-bis(t-butylperoxy)-3,3,5-trimethylcyclohexane, t-butyl cumyl peroxide, t-butyl peroxybenzoate, t-butyl peroxy-2-ethylhexyl carbonate, and any others that can react with single carbon-carbon bonds and thus produce a higher curing density. The term “peroxide” also includes “hydroperoxides”. Many commercially available peroxides are supplied at 40-50% activity with the remainder of the commercial composition being inert silica or calcium carbonate particles. The peroxide vulcanizing compositions generally also comprise one or more co-reagents at a molar ratio to the total peroxides of from 1:6 to 25:1. Useful co-reagents include but are not limited to, triallyl cyanurate (TAC), triallyl isocyanurate, triallyl trimellitate, the esters of acrylic and methacrylic acids with polyvalent alcohols, trimethylprpane trimethacrylate (TMPTMA), trimethylolpropane triacrylate (TMPTA), ethylene glycol dimethacrylate (EGDMA), and N,N′-m-phenylenedimaleimide (HVA-2, DuPont) to enhance the liberation of free radicals from the peroxides. Some useful peroxide compositions consist essentially of: (1) one or more peroxides, and particularly mixtures of first and second peroxides described below, and (2) one or more co-reagents. Other useful peroxides and co-reagents (such as Type I and Type II compounds) are well known in the art.

It is particularly useful to use a mixture of at least first and second peroxides in a peroxide vulcanizing composition, wherein the first peroxide has a t₉₀ value of at least 1 minute and up to and including 6 minutes, typically at least 2 minutes and up to and including 6 minutes, as measured at 160° C., and the second peroxide has a t₉₀ value of at least 8 minutes and up to and including 20 minutes, or typically at least 10 minutes and up to and including 20 minutes, as measured at 160° C. Useful examples of the first peroxides include but are not limited to, t-butyl peroxybenzoate, 1,1′-bis(t-butylperoxy)-3,3,5-trimethylcyclohexane, t-butylperoxy 2-ethylhexyl carbonate, and butyl 4,4′-di (t-butylperoxy)valerate. Useful examples of the second peroxides include but are not limited to, di(t-butylperoxyisopropyl)benzene, dicumyl peroxide, t-butyl cumyl peroxide, and 2,5-dimethyl-2,5 bis(t-butyl)peroxy)hexane. Other representative first and second peroxides could be easily determined by consulting known information about the t₉₀ values for various peroxides.

The molar ratio of the first peroxide to the second peroxide is generally from 1:4 to and including 5:1, or typically from 1:1.5 to and including 3:1.

These mixtures of first and second peroxides can also comprise one or more co-reagents as described above. In some embodiments, useful peroxide vulcanizing compositions consist essentially of: (1) one or more first peroxides, (2) one or more second peroxides, and (3) one or more co-reagents.

The mixtures comprising at least one first peroxide and at least one second peroxide can further comprise additional peroxides as long as the laser-engraveable composition has the desired characteristics described herein. For example, it is particularly useful that the laser-engraveable composition exhibit a t₉₀ value of at least 1 minute and up to and including 17 minutes at 160° C.

Still other useful vulcanizing compositions comprise at least one of sulfur or a sulfur-containing compound (with or without an accelerator), and at least one peroxide (with or without a co-reagent). Thus, some of these vulcanizing compositions comprise: (1) sulfur or a sulfur-containing compound, (2) a first peroxide, (3) a second peroxide, (4) one or more accelerators, and (5) one or more co-reagents, all as described above. Still other useful vulcanizing compositions consist essentially of (1) a sulfur or a sulfur-containing compound, (2) one or more accelerators, (3) one or more peroxides (such as a mixture of a first and second peroxides), and (4) one or more co-reagents, all as described above.

The laser-engraveable composition (and layer) used in this invention can optionally comprise one or more types non-metallic fibers that can be obtained from various non-metallic sources. For example, the non-metallic fibers can be derived from an animal, plant, or mineral source, or they can be provided as carbon or naturally-occurring or synthetic polymeric fibers. The non-metallic fibers are aligned or oriented predominantly in one of the two orthogonal dimensions of the laser-engraveable layer (precursor).

For example, when the flexographic printing precursor is prepared in the form of a continuous web or roll that can be cut into individual flexographic printing plate precursors, the continuous lengthwise dimension is generally greater than the crosswise (widthwise) dimension. In such embodiments, the non-metallic fibers described herein are oriented predominantly in the lengthwise dimension along the continuous roll.

Further details of such non-metallic fibers and the means for their orientation in the laser-engraveable composition are provided in copending and commonly assigned U.S. Ser. No. 13/245,893 (filed Sep. 27, 2011 by Gal and Melamed, Docket K000330/JLT), which is incorporated herein by reference. Particularly useful embodiments of the laser-engraveable layer comprise polypropylene fibers, polyimide fibers, polyester fibers, phenol-formaldehyde fibers, polyurethane fibers, polyvinyl alcohol fibers, poly(vinyl chloride) fibers, carbon fibers, glass fibers, or basalt fibers that are oriented in the laser-engraveable layer predominantly in one of its two orthogonal dimensions such as the lengthwise dimension of a continuous web or roll. The average size length and diameter of the oriented non-metallic fibers can vary according to the type and composition of fibers used and the thickness and composition of the laser-engraveable composition into which they are incorporated. Generally, it has been found that useful average non-metallic fiber length is at least 0.1 mm and up to and including 15 mm, or typically at least 0.2 mm and up to and including 10 mm. In addition, the average non-metallic fiber diameter is at least 1 μm and up to and including 100 μm, or typically at least 10 μm and up to and including 50 μm. The non-metallic fibers are generally introduced into the laser-engraveable composition (layer) as described below in an amount of at least 1 phr and up to and including 30 phr.

The laser-engraveable composition or layer can further comprise microcapsules that are dispersed generally uniformly within the laser-engraveable composition. These “microcapsules” can also be known as “hollow beads”, “hollow spheres”, “microspheres”, microbubbles”, “micro-balloons”, “porous beads”, or “porous particles”. Some microcapsules include a thermoplastic polymeric outer shell and a core of either air or a volatile liquid such as isopentane or isobutane. The microcapsules can comprise a single center core or many voids (pores) within the core. The voids can be interconnected or non-connected. For example, non-laser-ablatable microcapsules can be designed like those described in U.S. Pat. Nos. 4,060,032 (Evans) and 6,989,220 (Kanga) in which the shell is composed of a poly[vinylidene-(meth)acrylonitrile] resin or poly(vinylidene chloride), or as plastic micro-balloons as described for example in U.S. Pat. Nos. 6,090,529 (Gelbart) and 6,159,659 (Gelbart). The amount of microspheres present in the laser-engraveable composition or layer can be at least 1 phr and up to and including 15 phr. Some useful microcapsules are the EXPANCEL® microspheres that are commercially available from Akzo Noble Industries (Duluth, Ga.), Dualite and Micropearl polymeric microspheres that are available from Pierce & Stevens Corporation (Buffalo, N.Y.), hollow plastic pigments that are available from Dow Chemical Company (Midland, Mich.) and Rohm and Haas (Philadelphia, Pa.). The useful microcapsules generally have a diameter of 50 μm or less.

Upon laser-engraving, the microspheres that are hollow or filled with an inert solvent, burst and give a foam-like structure or facilitate ablation of material from the laser-engraveable layer because they reduce the energy needed for ablation.

Optional addenda in the laser-engraveable composition or layer also include but are not limited to, dyes, antioxidants, antiozonants, stabilizers, dispersing aids, surfactants, and adhesion promoters, as long as they do not interfere with laser-engraving efficiency.

The flexographic printing precursor of this invention generally has a laser-engraveable layer having a Δ torque (M_{Δ}=M_{H}−M_{L}) of at least 10 and up to and including 25, or typically of at least 13 and up to and including 22, wherein the components of this equation are defined above.

The laser-engraveable layer incorporated into the flexographic printing precursors of this invention has a dry thickness of at least 50 μm and up to and including 4,000 μm, or typically of at least 200 μm and up to and including 2,000 μm.

The flexographic printing precursors of this invention can comprise one or more layers. Thus, the precursors can comprise multiple layers, at least one of which is the laser-engraveable layer in which the relief image is formed. There can be a non-laser-engraveable elastomeric rubber layer (for example, a cushioning layer) between a substrate and the laser-engraveable layer.

In most embodiments, the laser-engraveable layer is the outermost layer of the flexographic printing precursors, including embodiments where the laser-engraveable layer is disposed on a printing cylinder as a sleeve. However, in some embodiments, the laser-engraveable layer can be located underneath an outermost capping smoothing layer that provides additional smoothness or better ink reception and release. This smoothing layer can have a general thickness of at least 1 μm and up to and including 200

The flexographic printing precursors of this invention can comprise a self-supporting laser-engraveable layer (defined above) that does not need a separate substrate to provide physical integrity and strength. In such embodiments, the laser-engraveable layer is thick enough and laser engraving is controlled in such a manner that the relief image depth is less than the entire thickness, for example at least 20% and up to and including 80% of the entire dry layer thickness.

However, in other embodiments, the flexographic printing precursor of this invention has a suitable dimensionally stable, non-laser-engraveable substrate having an imaging side and a non-imaging side. The substrate has at least one laser-engraveable layer disposed on the imaging side. Suitable substrates include dimensionally stable polymeric films, aluminum sheets or cylinders, transparent foams, ceramics, fabrics, or laminates of polymeric films (from condensation or addition polymers) and metal sheets such as a laminate of a polyester and aluminum sheet or polyester/polyamide laminates, or a laminate of a polyester film and a compliant or adhesive support. Polyester, polycarbonate, polyvinyl, and polystyrene films are typically used. Useful polyesters include but are not limited to poly(ethylene terephthalate) and poly(ethylene naphthalate). The substrates can have any suitable thickness, but generally they are at least 0.01 mm or at least 0.05 mm and up to and including 0.5 mm thick. An adhesive layer can be used to secure the laser-engraveable layer to the substrate.

Some particularly useful substrates comprise one or more layers of a metal, fabric, or polymeric film, or a combination thereof. For example, a fabric web can be applied to a polyester or aluminum support using a suitable adhesive. For example, the fabric web can have a thickness of at least 0.1 mm and up to and including 0.5 mm, and the polyester support thickness can be at least 100 μm and up to and including 200 μm, or the aluminum support can have a thickness of at least 200 μm and up to and including 400 μm. The dry adhesive thickness can be at least 10 μm and up to and including 80 μm.

There can be a non-laser-engraveable backcoat on the non-imaging side of the substrate (if present) that can comprise a soft rubber or foam, or other compliant layer. This non-laser-engraveable backcoat can provide adhesion between the substrate and printing press rollers and can provide extra compliance to the resulting flexographic printing member, or for example to reduce or control the curl of a resulting flexographic printing plate.

### Preparation of Flexographic Printing Precursors

The flexographic printing precursors of this invention can be prepared in the following manner:

A mixture of one or more elastomeric rubbers (EPDM or non-EPDM elastomeric rubbers) can be formulated with desired weight ratios. This mixture can also be formulated to include one or more high molecular weight EPDM elastomeric rubbers, one or more low molecular weight EPDM elastomeric rubbers, or both a high molecular weight EPDM elastomeric rubber and a low molecular weight EPDM elastomeric rubbers, all at desired weight amounts (based on phr). Additional components (such as the non-radiation absorber fillers, near-infrared radiation absorbers including carbon nanotubes, but not the vulcanizing composition) can be added and the resulting mixture is then compounded using standard equipment for rubber processing (for example, a t-roll mill or internal mixer of the Banbury type). During this mixing process, the temperature of the formulation can rise to 110° C. due to the high shear forces in the mixing apparatus. Mixing (or formulating) generally would require at least 5 and up to and including 30 minutes depending upon the formulation batch size, amount of non-radiation absorber fillers, types and amounts of the various elastomeric rubbers, the amount of any non-elastomeric resins, and other factors known to a skilled artisan.

The vulcanizing composition can then be added to standard equipment and the temperature of the formulation is kept below 70° C. so vulcanizing will not begin prematurely.

The compounded formulation can be strained to remove undesirable extraneous matter and then fed into a calender to deposit or apply a continuous sheet of the laser-engraveable formulation onto a carrier base (such as a fabric web) and wound into a continuous roll of a dry laser-engraveable layer on the fabric base.

Controlling the laser-engraveable layer (sheet) thickness is accomplished by adjusting the pressure between the calender rolls and the calendering speed. In some cases, where the laser-engraveable formulation does not stick to the calender rollers, the rollers are heated to improve the tackiness of the formulation and to provide some adhesion to the calender rollers. This continuous roll of calendered material can be vulcanized using a “rotacure” system under desired temperature and pressure conditions. For example, the temperature can be at least 150° C. and up to and including 180° C. over a period of at least 2 minutes and up to and including 15 minutes. For example, using a sulfur vulcanizing composition, the curing conditions are generally about 165° C. for about 15 minutes. Shorter curing times can be used if higher than atmospheric pressure is used. For vulcanizing peroxide compositions, for example comprising the peroxide product Perkadox® 14/40 (Kayaku Akzo), the curing conditions would can be about 165° C. for about 4 minutes followed by a post-curing stage at a temperature of 240° C. for 120 minutes.

The continuous laser-engraveable layer (for example, on a fabric web) can then be laminated (or adhered) to a suitable polymeric film such as a polyester film to provide the laser-engraveable layer on a substrate, for example, the fabric web adhered with an adhesive to the polyester film. The continuous laser-engraveable layer can be ground using suitable grinding apparatus to provide a uniform smoothness and thickness in the continuous laser-engraveable layer. The smooth, uniformly thick laser-engraveable layer can then be cut to a desired size to provide suitable flexographic printing plate precursors of this invention.

The process for making flexographic printing sleeves is similar but the compounded laser-engraveable layer formulation can be applied or deposited around a printing sleeve core and processed to form a continuous laser-engraveable flexographic printing sleeve precursor that is then vulcanized in a suitable manner and ground to a uniform thickness using suitable grinding equipment.

Similarly, a continuously calendered laser-engraveable layer on a fabric web can be deposited around a printing cylinder and processed to form a continuous flexographic printing cylinder precursor.

The flexographic printing precursor can also be constructed with a suitable protective layer or slip film (with release properties or a release agent) in a cover sheet that is removed prior to laser-engraving. The protective layer can be a polyester film [such as poly(ethylene terephthalate)] forming the cover sheet.

Moreover, the method of this invention can also comprise applying a compounded elastomeric rubber composition to a fabric web before vulcanizing, and adhering the fabric web having the vulcanized, compounded elastomeric rubber composition to a suitable substrate, such as a polymer film or metal sheet.

In addition, the fabric web can be provided as a continuous web and the substrate can be a polyester web so that the resulting flexographic printing precursor is in the form of a continuous precursor web. The fabric web can be adhered to the polyester web using a suitable adhesive.

The method can further comprise calibrating (for example, grinding) the laser-engraveable layer of the flexographic printing precursor to a desired uniform thickness, for example, using a suitable grinding process and apparatus.

As noted above, the compounded elastomeric rubber composition can comprise a near-infrared radiation absorber such as carbon nanotubes, a vulcanizing composition (such as the mixture of first and second peroxides), and one or more non-infrared radiation absorber fillers.

Thus, the method can be used to provide a flexographic printing plate precursor, or the substrate is a printing sleeve core and the method provides a flexographic printing sleeve precursor.

### Laser-Engraving Imaging to Prepare Flexographic Printing Members, and Flexographic Printing

Laser engraving can be accomplished using a near-IR radiation emitting diode or carbon dioxide or Nd:YAG laser. It is desired to laser engrave the laser-engraveable layer to provide a relief image with a minimum dry depth of at least 50 μm or typically of at least 100 μm. More likely, the minimum relief image depth is at least 300 μm and up to and including 4000 μm or up to 1000 μm being more desirable. Relief is defined as the difference measured between the floor of the imaged flexographic printing member and its outermost print surface. The relief image can have a maximum depth up to 100% of the original dry thickness of the laser-engraveable layer if it is disposed directly on a substrate or underlayer. In such instances, the floor of the relief image can be the substrate (if the laser-engraveable layer is completely removed in the imaged regions), a lower region of the laser-engraveable layer, or an underlayer such as an adhesive layer or compliant layer. When a substrate is absent, the relief image can have a maximum depth of up to 80% of the original dry thickness of the laser-engraveable layer. A semiconductor near-infrared radiation laser or array of such lasers operating at a wavelength of at least 700 nm and up to and including 1400 nm can be used, and a diode laser operating at from 800 nm to 1250 nm is particularly useful for laser-engraving.

Generally, laser-engraving is achieved using at least one near-infrared radiation laser having a minimum fluence level of at least 20 J/cm² at the imaged surface and typically near-infrared imaging fluence is at least 20 J/cm² and up to and including 1,000 J/cm² or typically at least 50 J/cm² and up to and including 800 J/cm².

A suitable laser engraver that would provide satisfactory engraving is described in WO 2007/149208 (Eyal et al.) that is incorporated herein by reference. This laser engraver is considered to be a “high powered” laser ablating imager or engraver and has at least two laser diodes emitting radiation in one or more near-infrared radiation wavelengths so that imaging with the one or more near-infrared radiation wavelengths is carried out at the same or different depths relative to the outer surface of the laser-engraveable layer. For example, the multi-beam optical head described in the noted publication incorporates numerous laser diodes, each laser diode having a power in the order of at least 10 Watts per emitter width of 100 μm. These lasers can be modulated directly at relatively high frequencies without the need for external modulators.

Thus, laser-engraving (laser imaging) can be carried out at the same or different relief image depths relative to the outer surface of the laser-engraveable layer using two or more laser diodes, each laser diode emitting near-infrared radiation in one or more wavelengths.

Other imaging (or engraving) devices and components thereof and methods are described for example in U.S. Patent Application Publications 2008/0153038 (Siman-Tov et al.) describing a hybrid optical head for direct engraving, 2008/0305436 (Shishkin) describing a method of imaging one or more graphical pieces in a flexographic printing plate precursor on a drum, 2009/0057268 (Aviel) describing imaging devices with at least two laser sources and mirrors or prisms put in front of the laser sources to alter the optical laser paths, and 2009/0101034 (Aviel) describing an apparatus for providing an uniform imaging surface, all of which publications are incorporated herein by reference. In addition, U.S. Patent Application Publication 2011/0014573 (Matzner et al.) describes an engraving system including an optical imaging head, a printing plate construction, and a source of imaging near-infrared radiation, which publication is incorporated herein by reference. U.S. Patent Application Publication 2011/0058010 (Aviel et al.) describes an imaging head for 3D imaging of flexographic printing plate precursors using multiple lasers, which publication is also incorporated herein by reference.

Thus, a system for providing flexographic printing members including flexographic printing plates, flexographic printing cylinders, and flexographic printing sleeves includes one or more of the flexographic printing precursors described above, as well as one or more groups of one or more sources of imaging (engraving) near-infrared radiation, each source capable of emitting near-infrared radiation (see references cited above) of the same or different wavelengths. Such imaging sources can include but are not limited to, laser diodes, multi-emitter laser diodes, laser bars, laser stacks, fiber lasers, and combinations thereof. The system can also include one or more sets of optical elements coupled to the sources of imaging (engraving) near-infrared radiation to direct imaging near-infrared radiation from the sources onto the flexographic printing precursor (see references cited above for examples of optical elements).

Engraving to form a relief image can occur in various contexts. For example, sheet-like elements can be imaged and used as desired, or wrapped around a printing sleeve core or cylinder form before imaging. The flexographic printing precursor can also be a flexographic printing sleeve precursor or flexographic printing cylinder precursor that can be imaged.

During imaging, products from the engraving can be gaseous or volatile and readily collected by vacuum for disposal or chemical treatment. Any solid debris from engraving can be collected and removed using suitable means such as vacuum, compressed air, brushing with brushes, rinsing with water, ultrasound, or any combination of these.

During printing, the resulting flexographic printing plate, flexographic printing cylinder, or printing sleeve is typically inked using known methods and the ink is appropriately transferred to a suitable substrate such as papers, plastics, fabrics, paperboard, metals, particle board, wall board, or cardboard.

After printing, the flexographic printing plate or sleeve can be cleaned and reused and a flexographic printing cylinder can be scraped or otherwise cleaned and reused as needed. Cleaning can be accomplished with compressed air, water, or a suitable aqueous solution, or by rubbing with cleaning brushes or pads.

A method of providing a flexographic printing plate or sleeve comprises:

imaging the flexographic printing precursor of this invention using near-infrared radiation to provide a relief image in the near-infrared radiation ablatable layer. This imaging can be carried out using a laser at a power of at least 20 J/cm². The method can further comprise removal of debris after imaging, such as for example, by vacuum, compressed air, brushes, rinsing with water, ultrasound, or any combination of these.

The imaging of this method can be carried out using a high power laser ablating imager, for example, wherein imaging is carried out at the same or different depths relative to the surface of the near-infrared radiation ablatable layer using two or more laser diodes each emitting radiation in one or more wavelengths.

The present invention also provides at least the following embodiments and combinations thereof, but other combinations of features are considered to be within the present invention as a skilled artisan would appreciate from the teaching of this disclosure:

1. A laser-engraveable composition comprising one or more elastomeric rubbers in an amount of at least 30 weight % and up to and including 80 weight %, based on the total laser-engravable composition weight, the laser-engraveable composition further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of: (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the inorganic non-infrared radiation absorber fillers to the total near-infrared radiation absorbers is from 1:35 to and including 13:1.

2. A patternable element that is laser-engraveable to provide a relief image, the patternable element comprising a laser-engraveable layer comprising one or more elastomeric rubbers in an amount of at least 30 weight % and up to and including 80 weight %, based on the total laser-engravable composition weight,

the laser-engraveable layer further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of: (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the non-infrared radiation absorber fillers to the total near-infrared radiation absorbers is from 1:35 to and including 13:1.

3. A flexographic printing precursor that is laser-engraveable to provide a relief image, the flexographic printing precursor comprising a laser—engraveable layer comprising one or more elastomeric rubbers in an amount of at least 30 weight % and up to and including 80 weight %, based on the total laser-engravable composition weight,

the laser-engraveable layer further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of: (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the inorganic non-infrared radiation absorber fillers to the total near-infrared radiation absorbers is from 1:35 to and including 13:1.

4. Any of embodiments 1 to 3 wherein the laser-engraveable composition or laser-engraveable layer further comprises a carbon black and wherein the weight ratio of the carbon black to carbon nanotubes is from 1:4 to and including 8:1.

5. Any of embodiments 1 to 4 wherein the laser-engraveable composition or laser-engraveable layer further comprises a carbon black and wherein the weight ratio of the carbon black to carbon nanotubes is from 1:1 to and including 4:1.

6. Any of embodiments 1 to 5 wherein the weight ratio of the vulcanizing composition to the total near-infrared radiation absorbers is from 1:3 to and including 1:1.

7. Any of embodiments 1 to 6 wherein the weight ratio of the inorganic non-infrared radiation absorber fillers to the total near-infrared radiation absorbers is from 1:12 to and including 5:1.

8. Any of embodiments 1 to 7 wherein the laser-engraveable composition or laser-engraveable layer further comprises a non-conductive carbon black.

9. Any of embodiments 1 to 8 wherein the laser-engraveable composition or laser-engraveable layer comprises at least 2 phr and up to and including 60 phr of the one or more inorganic, non-infrared radiation absorber fillers.

10. Any of embodiments 1 to 9 wherein the laser-engraveable composition or laser-engraveable layer comprises at least 7 phr and up to and including 12 phr of the vulcanizing composition.

11. Any of embodiments 1 to 10 wherein the laser-engraveable composition or laser-engraveable layer exhibits a t₉₀ value of at least 1 minute and up to and including 17 minutes at 160° C.

12. Any of embodiments 1 to 11 wherein the laser-engraveable composition or laser-engraveable layer comprises one or more EPDM elastomeric rubbers and optionally one or more CLCB EPDM elastomeric rubbers.

13. Any of embodiments 1 to 12 wherein the vulcanizing composition is a mixture of first and second peroxides wherein the first peroxide has a t₉₀ value of at least 1 minute and up to and including 6 minutes as measured at 160° C., and the second peroxide has a t₉₀ value of at least 8 minutes and up to and including 20 minutes as measured at 160° C.

14. Any of embodiments 2 to 13 wherein the laser-engraveable layer has a Δ torque (M_{Δ}=M_{H}−M_{L}) of at least 10 and up to and including 25.

15. Any of embodiments 2 to 14 further comprising a substrate over which the laser-engraveable layer is disposed, wherein the substrate comprises one or more layers of a metal, fabric, or polymeric film, or a combination thereof

16. Any of embodiments 2 to 15 further comprising a substrate over which the laser-engraveable layer is disposed, wherein the substrate comprises a fabric web disposed over a polyester support.

17. Any of embodiments 2 to 16 wherein the laser-engraveable layer has a dry thickness of at least 50 μm and up to and including 4,000 μm.

18. Any of embodiments 1 to 17 wherein the laser-engraveable composition or laser-engraveable layer further comprises a non-conductive carbon black.

19. A method for providing a patterned element or flexographic printing member comprising:

imaging the laser-engraveable layer of the flexographic printing precursor of any of embodiments 2 to 18 using near-infrared radiation to provide a flexographic printing member with a relief image in the resulting laser-engraved layer with a minimum dry relief depth of at least 50 μm.

20. The method of embodiment 19 comprising imaging using a semiconductor infrared radiation laser or array of such lasers at a minimum fluence level of at least 20 J/cm² and up to and including 1,000 J/cm².

21. The method of embodiment 19 or 20 comprising imaging using two or more laser diodes, each diode emitting near-infrared radiation at one or more wavelengths, in order to provide the same or different relief image depths relative to the outer surface of the laser-engraveable layer.

22. The method of any of embodiments 19 to 21 for providing a flexographic printing plate or flexographic printing sleeve.

23. A system for providing a patterned element or flexographic printing member, comprising:

any of embodiments 2 to 18,

a source of imaging near-infrared radiation that is capable of emitting imaging near-infrared radiation and that is selected from the group consisting of a laser diode, a multi-emitter laser diode, a laser bar, a laser stack, a fiber laser, or a combination thereof, and

a set of optical elements coupled to the one or more sources of imaging near-infrared radiation to direct imaging near-infrared radiation from the one or more sources of imaging near-infrared radiation onto the patternable element or flexographic printing precursor.

24. A method for preparing the patternable element or flexographic printing precursor of any of embodiments 2 to 18 comprising:

providing a laser-engraveable composition comprising one or more elastomeric rubbers in an amount of at least 30 weight % and up to and including 80 weight %, based on the total laser-engravable composition weight, the laser-engraveable composition further comprising the following components:

1) at least 1 phr and up to and including 80 phr of one or more inorganic, non-infrared radiation absorber fillers,

2) at least 3 phr and up to and including 20 phr of a vulcanizing composition that is selected from the group consisting of (a) a sulfur composition, (b) a peroxide composition, and (c) both a sulfur composition and a peroxide composition,

3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,

wherein the weight ratio of the carbon black, when present, to the carbon nanotubes is from 1:4 to and including 8:1,

wherein the weight ratio of the vulcanizing composition to the total near-infrared radiation absorbers is from 1:12 to and including 3:1, and

wherein the weight ratio of the non-infrared radiation absorber fillers to the total near-infrared radiation absorbers is from 1:35 to and including 13:1, and

formulating the laser-engraveable composition into a laser-engraveable layer.

25. The method of embodiment 24 comprising formulating the laser-engraveable composition into a laser-engraveable layer on a substrate.

26. The method of embodiment 24 or 25 comprising formulating the laser-engraveable composition into a laser-engraveable layer on a substrate as a continuous roll.

The following Examples are provided to illustrate the practice of this invention and are not meant to be limiting in any manner.

### Comparative Example 1

Sixty phr by weight of Keltan® 2340 (from DSM Elastomers) elastomeric rubber and 40 phr of another EPDM elastomeric rubber were masticated in a two roller mill. The grade of EPDM elastomeric rubber was based on ethylidene norborene and was the commercial grade Nordel 4725 (obtained from Dow Chemical Company). Mastication was continued until the shapeless lump in the mill had been formed into a semi-transparent sheet. This sheet was rolled up and fed into a Banbury mixer operating between 70° C. and 80° C. During the mixing, the following components (phr) were added individually in the order shown below:

| Keltan ® 2340 | 60 | phr |
|---|---|---|
| Nordel 4725 | 40 | phr |
| Stearic acid | 1 | phr |
| Zinc oxide | 5 | phr |
| N330 Carbon black | 24 | phr |
| | (non-conductive) | |
| Vinyl Silane | 1.5 | phr |
| N,N′-(m-phenylene)dimaleimide | 2.14 | phr |
| 70% active co-reagent (HVA-2) | | |
| Calcium Carbonate | 30 | phr |
| Mineral oil | 15 | phr. |

The formulation was mixed for about 20 minutes in the Banbury mixer until a constant stress reading could be observed on the Banbury mixer. The resulting composition was removed from the Banbury mixer as a homogenous lump that was fed onto a two roller mill and 3 phr of di-(t-butylperoxyisopropyl)benzene and 5 phr of 1,1-bis(t-butylperoxy)-3,3,5-trimethylcyclohexane were then added.

The Mooney viscosity of the resulting laser-engraveable layer formulation was about 58. The milled formulation was then fed through a calender at a temperature of 30-80° C. in combination with a fabric base. The calender gap was pre-set to desired thickness requirements. The resulting continuous roll of laminated laser-engraveable layer and fabric web was fed into an autoclave at 135° C. for a suitable period of time, and after cooling the continuous roll to room temperature, it was laminated to a 125 μm poly(ethylene terephthalate) film and post-cured in an autoclave at 120° C. to provide a flexographic printing plate precursor.

The EPDM elastomeric rubber was present in the dry laser-engraveable layer in an amount of 48% based on the total dry layer weight. Moreover, the near-infrared radiation absorber (carbon black) was present in the dry laser-engraveable layer in an amount of 24 phr, and the total of the inorganic, non-infrared radiation absorber fillers (zinc oxide, calcium carbonate, and stearic acid) was 36 phr. Thus, the weight ratio of the near-infrared radiation absorber to the inorganic, non-infrared radiation absorber fillers was about 1:1.5. The amount of the vulcanizing composition (including peroxide and co-reagent) used to prepare the laser-engraveable layer was 5 phr, and the weight ratio of the near-infrared radiation absorber to the vulcanizing composition in the laser-engraveable layer formulation was 5:1.

The laser-engraveable layer of this flexographic printing plate precursor was then continuously ground to provide a uniform thickness using a buffing machine. The flexographic printing plate precursor had a Durometer hardness of 57. It was cut to an appropriate size and placed on a laser-engraving plate imager where an excellent, sharp, and deep relief image was produced that was then used on a flexographic printing press to produce hundreds of thousands of sharp, clean impressions. The compression set for this flexographic printing plate was found to be 28% as measured according to ASTM D 395 Method B.

The flexographic printing plate precursor was evaluated using an Impression Roller Tester 6208 instrument and found to have a grounding resistance of 10¹¹ ohms, which means that the precursor conductivity was 10⁻¹¹ mhos and it was non-conductive.

### Comparative Example 2

Comparative Example 1 was repeated except that the laser-engraveable layer was formulated using added 3 phr of carbon nanotubes (Baytubes C 150P). The resulting flexographic plate precursor had a Durometer hardness of 66.

The non-conductive carbon black with a dibutyl phthalate (DBP) absorption value of less than 110 ml/100 g was present in the dry laser engraveable layer in an amount of 24 phr, and the amount of the carbon nanotubes was 3 phr. Thus, the weight ratio of the non-conductive carbon black to the carbon nanotubes was 8:1. The total amount of the near-infrared radiation absorber was 27 phr (non-conductive carbon black and carbon nanotubes), and the total of the inorganic, non-infrared radiation absorber fillers (zinc oxide, stearic acid, and calcium carbonate) was 36 phr. Thus the weight ratio of the total near-infrared radiation absorbers to the inorganic, non-infrared radiation absorber was about 1:1.3. The amount of the vulcanizing composition (including peroxide and co-reagent) used to prepare the laser-engraveable layer was 5 phr, and the weight ratio of the total near-infrared radiation absorbers to the vulcanizing composition in the laser-engraveable layer formulation was about 5.5:1.

The resulting precursor was evaluated for grounding resistance using the Impression Roller Tester 6208 instrument and found to be >10¹¹ ohm, which means that the precursor was non-conductive. The amount of added carbon nanotubes did not affect the sensitivity of the resulting flexographic printing plate precursor and other physical properties, but conductivity was not achieved.

### Invention Example 1

Comparative example 2 was repeated except that the laser-engraveable layer was formulated using 4 phr of carbon nanotubes (Baytubes® C70P). The resulting flexographic printing plate precursor had a Durometer hardness of 63.

The non-conductive carbon black having a dibutyl phthalate (DBP) absorption value of less than 110 ml/100 g was present in the dry laser engraveable layer in an amount of 24 phr, and the amount of the carbon nanotubes was 4 phr providing a total near-infrared radiation absorber amount of 28 phr. Thus, the weight ratio of the non-conductive carbon black to the carbon nanotubes was 6:1, and the total of the inorganic, non-infrared radiation absorber fillers (zinc oxide, stearic acid, and calcium carbonate) was 36 phr. Thus the weight ratio of the near-infrared radiation absorber to the inorganic, non-infrared radiation absorber was about 1:1.5. The amount of the vulcanizing composition (including peroxide and co-reagent) used to prepare the laser-engraveable layer was 5 phr, and the weight ratio of the total near-infrared radiation absorbers to the vulcanizing composition in the laser-engraveable layer formulation was about 5.5:1.

The resulting flexographic printing plate precursor was cut to an appropriate size and were placed on a laser-engraving plate imager where an excellent, sharp, and deep relief image was produced that was used on a flexographic printing press to produce hundreds of thousands of sharp, clean impressions. The compression set for the flexographic printing plate was 26% as measured according to ASTM D 395 Method B.

The resulting flexographic printing plate precursor was evaluated using an Impression Roller Tester 6208 and found to have a grounding resistance of 10⁷ ohms, which means that the precursor conductivity was 10⁻⁷ mhos. Thus, the precursor was conductive. The amount of added carbon nanotubes did not adversely affect the sensitivity of the flexographic printing plate precursor or other physical properties. Thus, it is best to include the carbon nanotubes in the laser-engraveable formulation (and resulting precursor layer) in an amount of at least 4 phr.

### Comparative Example 3

Comparative Example 1 was repeated except that the laser-engraveable layer was formulated using a mixture of 40 phr SBR, 20 phr of polybutadiene rubber, and 40 phr of natural rubber. The resulting flexographic printing plate precursor had a Durometer hardness of 67.

The total EPDM elastomeric rubbers were present in the dry laser-engraveable layer in an amount of 60% based on the total dry layer weight. Moreover, the near-infrared radiation absorber (non-conductive carbon black) was present in the dry laser-engraveable layer in an amount of 24 phr, and the total of the inorganic, non-infrared radiation absorber fillers (zinc oxide, calcium carbonate, and silica) was 36 phr. Thus, the weight ratio of the near-infrared radiation absorber to the inorganic, non-infrared radiation absorber fillers was about 1:1.5. The amount of the vulcanizing composition (including peroxide and co-reagent) used to prepare the laser-engraveable layer was 5 phr, and the weight ratio of the near-infrared radiation absorber to the vulcanizing composition in the laser-engraveable layer formulation was 5:1.

The resulting flexographic printing precursor was cut to an appropriate size and placed on a laser-engraving plate imager where an excellent, sharp, and deep relief image was produced that was then used on a flexographic printing press to produce hundreds of thousands of sharp, clean impressions. The precursor was evaluated using an Impression Roller Tester 6208 instrument and found to have a grounding resistance of >10¹¹ ohms, which means that the precursor had a conductivity 10⁻¹¹ mhos and that it was non-conductive.

### Invention Example 2

Comparative Example 3 was repeated except that the laser-engraveable layer was formulated using a mixture of 4 phr carbon nanotubes (Baytubes® C80P). The resulting flexographic plate precursor had a Durometer hardness of 64.

The non-conductive carbon black with a dibutyl phthalate (DBP) absorption value of less than 110 ml/100 g was present in the dry laser-engraveable layer in an amount of 24 phr, and the amount of the carbon nanotubes was 4 phr. Thus, the weight ratio of the non-conductive carbon black to the carbon nanotubes was 6:1. The total amount of the near-infrared radiation absorber was 28, and the total of the inorganic, non-infrared radiation absorber fillers (zinc oxide, stearic acid, and calcium carbonate) was 36 phr. Thus, the weight ratio of the total near-infrared radiation absorber to the inorganic, non-infrared radiation absorber was about 1:1.5. The amount of the vulcanizing composition (including peroxide and co-reagent) used to prepare the laser-engraveable layer was 5 phr, and the weight ratio of the total near-infrared radiation absorbers to the vulcanizing composition in the laser-engraveable layer formulation was about 5.5:1.

The resulting flexographic printing plate precursor was cut to an appropriate size and placed on a laser-engraving plate imager where an excellent, sharp, and deep relief image was produced that was then used on a flexographic printing press to produce hundreds of thousands of sharp, clean impressions. The precursor was evaluated using an Impression Roller Tester 6208 instrument and determined to have a grounding resistance of 10⁷ ohms, which means that the precursor conductivity was 10⁴ mhos indicating that it was conductive. The amount of added carbon nanotubes did not adversely affect the sensitivity of the flexographic printing plate precursor and other physical properties.

### Invention Example 3

The amount of the inorganic, non-infrared radiation absorber filler(s) in the laser engraveable layer can affect the layer hardness (evaluated as the Durometer hardness) and the conductivity of the layer. Evaluations of using various amounts of one inorganic, non-infrared radiation absorber filler, silica, are shown in the following TABLE I when the indicated amounts of silica were formulated into laser-engraveable layer like that described above in Invention Example 1.

TABLE I

| Silica (phr) | 0 | 25 | 40 |
|---|---|---|---|
| Durometer | 63 | 77 | 87 |
| Hardness | | | |
| Torque Value M_{H} | 13 | 20 | 29 |
| Conductivity | 10⁻⁷ | 10⁻⁷ | 6.10⁻⁹ |
| (mho) | | | |

It can be seen from these data that higher silica amounts (in phr) caused an increase in laser-engraveable layer hardness and this effect can affect printing performances. Higher amounts of silica influenced the conductivity of the precursor so at higher amounts, the precursor became more non-conductive. Thus, it is best to include the silica, with or without other inorganic, non-infrared radiation absorber filler(s), in the laser-engraveable formulation (and resulting precursor layer) in an amount of up to and including 35 phr, or typically in an amount of at least 1 phr and up to and including 25 phr.

### Invention Example 4

The amount of the inorganic, non-infrared radiation absorber filler in the laser-engraveable layer can affect both layer conductivity and abrasion resistance of the layer. Evaluations of the use of various amounts of one inorganic, non-infrared radiation absorber filler, calcium carbonate, are shown in the following TABLE II when the indicated amounts of calcium carbonate were formulated into laser engraveable layer like that described above in Invention Example 1.

TABLE II

| Calcium Carbonate( phr) | 30 | 60 |
|---|---|---|
| Torque Value M_{H} | 13 | 29 |
| Conductivity (mho) | 10⁻⁷ | 10⁻⁷ |
| Abrasion resistance loss | 0.195 | 0.383 |
| (mg/revolution) | | |

The “abrasion resistance loss” was measured as a Taber abrasion according to ASTM D1044 using known procedures and equipment. The torque values and conductivities were measured as described above.

It can be seen from these data that the higher calcium carbonate amounts (in phr) caused an increase in the laser-engraveable layer abrasion resistance, which can affect printing performances and layer wear after many impressions are made during. However, higher amounts of calcium carbonate did not influence the conductivity of the plate so despite the higher amounts of calcium carbonate, the precursor remained conductive. Thus, it is best to include the calcium carbonate, with or without other inorganic, non-infrared radiation absorber filler(s), in the laser-engraveable formulation (and resulting precursor layer) in an amount up to and including 40 phr, or typically in an amount of at least 20 phr and up to and including 30 phr.

### Invention Example 5

It is also useful to include a mineral oil in the laser engraveable layer because the presence and amount of a mineral oil can affect the calendering process, hardness of the resulting laser-engraveable layer, the Mooney viscosity and the conductivity of the resulting precursor. Paraffin oil was used in laser-engraveable layers like that described above in Invention Example 1 in the amounts shown in TABLE III below. The results in Mooney viscosity, Durometer hardness, torque values, and conductivity of the laser-engraveable formulations and the resulting laser-engraveable layer were measured as described above and are also shown in TABLE III.

TABLE III

| Paraffin Oil (phr) | 15 | 25 | 35 |
|---|---|---|---|
| Mooney Viscosity | 45 | 35 | 29 |
| Torque Value M_{H} | 13 | 9 | 7 |
| Durometer Hardness | 63 | 54 | 44 |
| Conductivity (mho) | 10⁻⁷ | 10⁻⁹ − 10⁻¹⁰ | 10⁻⁹ − 10⁻¹⁰ |

These data indicate that the Mooney viscosity values decreased with the increasing amount of mineral oil. As these values decreased, there were increasing problems with calendering. Furthermore the laser-engraveable precursor became less conductive when the amount of mineral oil was increased. Thus, when a mineral oil is present in the laser engraveable layer formulation, it is desirable to use it in an amount of at least 5 phr and up to and including 15 phr.

### Invention Example 6

Comparative Example 1 was repeated except that the laser-engraveable layer was formulated using 10 phr of carbon nanotubes (Baytubes®C70P) instead of the non-conductive carbon black with a dibutyl phthalate (DBP) absorption value of less than 110 ml/100 g. The resulting flexographic printing plate precursor had a Durometer hardness of 70.

The amount of the total near-infrared radiation absorber was 10 phr, and the total of the inorganic, non-infrared radiation absorber fillers (zinc oxide, stearic acid and calcium carbonate) was 36 phr. Thus the weight ratio of the near-infrared radiation absorber to the inorganic, non-infrared radiation absorber was about 1:3.5. The amount of the vulcanizing composition (including peroxide and co-reagent) used to prepare the laser-engraveable layer was 5 phr, and the weight ratio of the near-infrared radiation absorber to the vulcanizing composition in the laser-engraveable layer formulation was about 2:1.

The resulting flexographic printing precursor was cut to an appropriate size and placed on a laser-engraving plate imager where an excellent, sharp, and deep relief image was produced that was then used on a flexographic printing press to produce hundreds of thousands of sharp, clean impressions. The produced plate was evaluated using an Impression Roller Tester 6208 instrument and found to have a grounding resistance of 10⁴ ohms, which means that the precursor conductivity was 10⁴ mhos and the precursor was very conductive. The amount of added carbon nanotubes did not adversely affect the sensitivity of the produced flexographic plate precursor or other physical properties.

While this flexographic plate precursor exhibits excellent results the price of carbon nanotubes is so high that it is preferred to use them in combination with other less expensive near-infrared radiation absorbers, such as non-conductive carbon blacks.

The invention has been described in detail with particular reference to certain preferred embodiments thereof, but it will be understood that variations and modifications can be effected within the spirit and scope of the invention.

1. A laser-engraveable composition comprising one or more elastomeric rubbers in an amount of at least 30 weight % and up to and including 80 weight %, based on the total laser-engravable composition weight, the laser-engraveable composition further comprising the following components:
1) at least 1 phr and up to and including 80 phr of one or more inorganic, non-infrared radiation absorber fillers,
2) at least 3 phr and up to and including 20 phr of a vulcanizing composition that is selected from the group consisting of: (a) a sulfur composition, (b) a peroxide composition, and (c) both a sulfur composition and a peroxide composition,
3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,
wherein the weight ratio of the carbon black, when present, to the carbon nanotubes is from 1:4 to and including 8:1,
wherein the weight ratio of the vulcanizing composition to the total near-infrared radiation absorbers is from 1:12 to and including 3:1, and
wherein the weight ratio of the inorganic non-infrared radiation absorber fillers to the total near-infrared radiation absorbers is from 1:35 to and including 13:1.

2. The laser-engraveable composition of claim 1 further comprising a carbon black and wherein the weight ratio of the carbon black to carbon nanotubes is from 1:4 to and including 8:1.

3. The laser-engraveable composition of claim 1 further comprising a carbon black and wherein the weight ratio of the carbon black to carbon nanotubes is from 1:1 to and including 4:1.

4. The laser-engraveable composition of claim 1 wherein the weight ratio of the vulcanizing composition to the total near-infrared radiation absorbers is from 1:3 to and including 1:1.

5. The laser-engraveable composition of claim 1 wherein the weight ratio of the inorganic non-infrared radiation absorber fillers to the total near-infrared radiation absorbers is from 1:12 to and including 5:1.

6. The laser-engraveable composition of claim 1 further comprising a non-conductive carbon black.

7. The laser-engraveable composition of claim 1 comprising at least 2 phr and up to and including 60 phr of the one or more inorganic, non-infrared radiation absorber fillers.

8. The laser-engraveable composition of claim 1 comprising at least 7 phr and up to and including 12 phr of the vulcanizing composition.

9. The laser-engraveable composition of claim 1 that exhibits a t₉₀ value of at least 1 minute and up to and including 17 minutes at 160° C.

10. The laser-engraveable composition of claim 1 comprising one or more EPDM elastomeric rubbers and optionally one or more CLCB EPDM elastomeric rubbers.

11. A flexographic printing precursor that is laser-engraveable to provide a relief image, the flexographic printing precursor comprising a laser—engraveable layer comprising one or more elastomeric rubbers in an amount of at least 30 weight % and up to and including 80 weight %, based on the total laser-engravable composition weight,
the laser-engraveable layer further comprising the following components:
1) at least 1 phr and up to and including 80 phr of one or more inorganic, non-infrared radiation absorber fillers,
2) at least 3 phr and up to and including 20 phr of a vulcanizing composition that is selected from the group consisting of: (a) a sulfur composition, (b) a peroxide composition, and (c) both a sulfur composition and a peroxide composition,
3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,
wherein the weight ratio of the carbon black, when present, to the carbon nanotubes is from 1:4 to and including 8:1,
wherein the weight ratio of the vulcanizing composition to the total near-infrared radiation absorbers is from 1:12 to and including 3:1, and
wherein the weight ratio of the inorganic non-infrared radiation absorber fillers to the total near-infrared radiation absorbers is from 1:35 to and including 13:1.

12. The flexographic printing precursor of claim 11 wherein the vulcanizing composition is a mixture of first and second peroxides wherein the first peroxide has a t₉₀ value of at least 1 minute and up to and including 6 minutes as measured at 160° C., and the second peroxide has a t₉₀ value of at least 8 minutes and up to and including 20 minutes as measured at 160° C.

13. The flexographic printing precursor of claim 11 wherein the laser-engraveable layer has a Δ torque (M_{Δ}=M_{H}−M_{L}) of at least 10 and up to and including 25.

14. The flexographic printing precursor of claim 11 further comprising a substrate over which the laser-engraveable layer is disposed, wherein the substrate comprises one or more layers of a metal, fabric, or polymeric film, or a combination thereof.

15. The flexographic printing precursor of claim 11 further comprising a substrate over which the laser-engraveable layer is disposed, wherein the substrate comprises a fabric web disposed over a polyester support.

16. The flexographic printing precursor of claim 11 wherein the laser-engraveable layer has a dry thickness of at least 50 μm and up to and including 4,000 μm.

17. The flexographic printing precursor of claim 11 wherein the laser-engraveable layer further comprises a carbon black and wherein the weight ratio of the carbon black to carbon nanotubes is from 1:1 to and including 4:1.

18. The flexographic printing precursor of claim 11 wherein the weight ratio of the vulcanizing composition to the total near-infrared radiation absorbers in the laser-engraveable layer is from 1:3 to and including 1:1.

19. The flexographic printing precursor of claim 11 wherein the weight ratio of the inorganic non-infrared radiation absorber fillers to the near-infrared radiation absorbers in the laser-engraveable layer is from 1:12 to and including 5:1.

20. The flexographic printing precursor of claim 11 further comprising a non-conductive carbon black.

21. The flexographic printing precursor of claim 11 wherein the laser-engraveable layer comprises at least 2 phr and up to and including 60 phr of the one or more inorganic, non-infrared radiation absorber fillers.

22. The flexographic printing precursor of claim 11 wherein the laser-engraveable layer comprises at least 7 phr and up to and including 12 phr of the vulcanizing composition.

23. The flexographic printing precursor of claim 11 that exhibits a t₉₀ value of at least 1 minute and up to and including 17 minutes at 160° C.

24. The flexographic printing precursor of claim 11 wherein the laser-engraveable layer comprises one or more EPDM elastomeric rubbers and optionally one or more non-CLCB EPDM elastomeric rubbers.

25. The flexographic printing precursor of claim 11 wherein the laser-engraveable layer is disposed on a substrate that comprises a fabric web disposed over a polyester support,
the laser-engraveable layer has a Δ torque (M_{Δ}=M_{H}−M_{L}) of at least 10 and up to and including 25 and a dry thickness of at least 100 μm and up to and including 3,000 μm, and comprises:
a vulcanizing composition that is a mixture of first and second peroxides wherein the first peroxide has a t₉₀ value of at least 1 minute and up to and including 6 minutes as measured at 160° C., and the second peroxide has a t₉₀ value of at least 8 minutes and up to and including 20 minutes as measured at 160° C., and the weight ratio of the vulcanizing composition to the total near-infrared radiation absorbers is from 1:3 to and including 1:1,
a non-conductive carbon black in an amount of at least 8 and up to and including 16 phr, wherein the weight ratio of the carbon black to carbon nanotubes is from 1:1 to and including 4:1,
wherein the weight ratio of the inorganic non-infrared radiation absorber fillers to the total near-infrared radiation absorbers in the laser-engraveable layer is from 1:12 to and including 5:1,
wherein the laser-engraveable layer comprises at least 2 phr and up to and including 60 phr of the one or more inorganic, non-infrared radiation absorber fillers,
wherein the laser-engraveable layer comprises at least 7 phr and up to and including 12 phr of the vulcanizing composition, and
wherein the laser-engraveable layer comprises one or more EPDM elastomeric rubbers and optionally one or more CLCB EPDM elastomeric rubbers.

26. A method for providing a flexographic printing member comprising:
imaging the laser-engraveable layer of the flexographic printing precursor of claim 11 using near-infrared radiation to provide a flexographic printing member with a relief image in the resulting laser-engraved layer with a minimum dry relief depth of at least 50 μm.

27. The method of claim 26 comprising imaging using a semiconductor infrared radiation laser or array of such lasers at a minimum fluence level of at least 20 J/cm² and up to and including 1,000 J/cm².

28. The method of claim 26 comprising imaging using two or more laser diodes, each diode emitting near-infrared radiation at one or more wavelengths, in order to provide the same or different relief image depths relative to the outer surface of the laser-engraveable layer.

29. The method of claim 26 for providing a flexographic printing plate or flexographic printing sleeve.

30. A system for providing a flexographic printing member, comprising:
the flexographic printing precursor of claim 11,
a source of imaging near-infrared radiation that is capable of emitting imaging near-infrared radiation and that is selected from the group consisting of a laser diode, a multi-emitter laser diode, a laser bar, a laser stack, a fiber laser, or a combination thereof, and
a set of optical elements coupled to the one or more sources of imaging near-infrared radiation to direct imaging near-infrared radiation from the one or more sources of imaging near-infrared radiation onto the flexographic printing precursor.

31. A method for preparing the flexographic printing precursor of claim 11 comprising:
providing a laser-engraveable composition comprising one or more elastomeric rubbers in an amount of at least 30 weight % and up to and including 80 weight %, based on the total laser-engravable composition weight, the laser-engraveable composition further comprising the following components:
1) at least 1 phr and up to and including 80 phr of one or more inorganic, non-infrared radiation absorber fillers,
2) at least 3 phr and up to and including 20 phr of a vulcanizing composition that is selected from the group consisting of (a) a sulfur composition, (b) a peroxide composition, and (c) both a sulfur composition and a peroxide composition,
3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,
wherein the weight ratio of the carbon black, when present, to the carbon nanotubes is from 1:4 to and including 8:1,
wherein the weight ratio of the vulcanizing composition to the total near-infrared radiation absorbers is from 1:12 to and including 3:1, and
wherein the weight ratio of the non-infrared radiation absorber fillers to the total near-infrared radiation absorbers is from 1:35 to and including 13:1, and
formulating the laser-engraveable composition into a laser-engraveable layer.

32. The method of claim 31 wherein the laser-engraveable composition exhibits a t₉₀ value of at least 1 minute and up to and including 17 minutes at 160° C.

33. The method of claim 31 comprising formulating the laser-engraveable composition into a laser-engraveable layer on a substrate.

34. The method of claim 31 comprising formulating the laser-engraveable composition into a laser-engraveable layer on a substrate as a continuous roll.

35. A patternable element that is laser-engraveable to provide a relief image, the patternable element comprising a laser-engraveable layer comprising one or more elastomeric rubbers in an amount of at least 30 weight % and up to and including 80 weight %, based on the total laser-engravable composition weight,
the laser-engraveable layer further comprising the following components:
1) at least 1 phr and up to and including 80 phr of one or more inorganic, non-infrared radiation absorber fillers,
2) at least 3 phr and up to and including 20 phr of a vulcanizing composition that is selected from the group consisting of: (a) a sulfur composition, (b) a peroxide composition, and (c) both a sulfur composition and a peroxide composition,
3) a near-infrared radiation absorber composition comprising at least 3 phr and up to and including 11 phr of carbon nanotubes, and optionally one or more additional near-infrared radiation absorbers, and if present, at least one of which is a carbon black that can be present in an amount of at least 3 phr and up to and including 24 phr,
wherein the weight ratio of the carbon black, when present, to the carbon nanotubes is from 1:4 to and including 8:1,
wherein the weight ratio of the vulcanizing composition to the total near-infrared radiation absorbers is from 1:12 to and including 3:1, and wherein the weight ratio of the non-infrared radiation absorber fillers to the total near-infrared radiation absorbers is from 1:35 to and including 13:1.
